(19) United States
(12) Patent Application Publication
(10) Pub. No.: US 2011/0109808 A1
(43) Pub. Date: May 12, 2011

(54) METHOD AND APPARATUS FOR FAST CHANNEL CHANGE USING A SECONDARY CHANNEL VIDEO STREAM

(75) Inventors: John Qiang Li, Belle Mead, NJ (US); Xiuping Lu, Hillsborough, NJ (US); Zhenyu Wu, Plainsboro, NJ (US)

(73) Assignee: THOMSON LICENSING, Issy Les Moulineaux (FR)

(21) Appl. No.: 12/737,416

(22) PCT Filed: Jul. 28, 2009
(86) PCT No.: PCT/US2009/004359

§ 371 Date: Jan. 11, 2011

Related U.S. Application Data
(60) Provisional application No. 61/084,064, filed on Jul. 28, 2008.

(51) Int. Cl. H04N 7/26; H04N 5/44

(52) U.S. Cl. 348/725; 375/240.25; 375/E07.027; 348/E05.096

(57) ABSTRACT

A method and apparatus for fast channel change when changing the channel from a channel being viewed full screen as a main picture to a channel being viewed in a secondary channel program display window (e.g., a picture-in-picture (PIP) window). In one implementation, during the channel change, a secondary video stream for a secondary channel program is up-sampled and displayed full screen while receiving the corresponding regular video stream for the video program, of which program contents are identical to those of the secondary video stream. The program contents of the up-sampled secondary video stream is then be replaced seamlessly with those of the corresponding regular video stream at the time when an instantaneous decode refresh (IDR) frame of the corresponding regular video stream is received. In another implementation, the last GOP packets of the corresponding regular video stream, corresponding to a secondary video stream being viewed in the secondary channel program display window, are buffered without being decoded. Upon a request for the channel change, the buffered GOP packets are decoded and displayed immediately while the decoder starts receiving the following frames in the corresponding regular video stream.

This application claims the benefit under 35 U.S.C. §119 of U.S. Provisional Application Filing No. 61/084,064, filed Jul. 28, 2008.

This application is related to the following co-pending, commonly owned, U.S. patent applications: (1) Ser. No. ______ entitled METHOD AND APPARATUS FOR FAST CHANNEL CHANGE FOR DIGITAL VIDEO filed on Jul. 25, 2007 as an international patent application (Filing No. PCT/US2007/016788, Thomson Docket No. PU060146); (2) Ser. No. ______ entitled AN ENCODING METHOD TO IMPROVE EFFICIENCY IN SVC FAST CHANNEL CHANGE filed on Jan. 16, 2009 as an international patent application (Filing No. PCT/US2009/000325, Thomson Docket No. PU080128); (3) Ser. No. ______ entitled AN RTP PACKETIZATION METHOD FOR FAST CHANNEL CHANGE APPLICATIONS USING SVC filed on Jan. 29, 2009 as an international patent application (Filing No. PCT/US08/006,333, Thomson Docket No. PU080133); (4) Ser. No. ______ entitled A SCALABLE VIDEO CODING METHOD FOR FAST CHANNEL CHANGE AND INCREASED ERROR RESILIENCE filed on Oct. 30, 2008 as an international patent application (Filing No. PCT/US2008/012303, Thomson Docket No. PU070272); and (5) Ser. No. ______ entitled METHOD AND APPARATUS FOR FAST CHANNEL CHANGE USING A SCALABLE VIDEO CODING (SVC) STREAM filed on July XX, 2009 as an international patent application (Filing No. XXX, Thomson Docket No. PU080136).

The present principles relate generally to digital video communication systems and, more particularly, to a method and apparatus for fast channel change between a video program of a regular video stream and a video program of the corresponding regular video stream, of which broadcast program contents are identical to those of a secondary channel video stream.

As used herein, the term “regular video” does not necessarily indicate that the quality of its program contents is “standard definition” (SD) quality. That is, “high-definition” (HD) quality program contents may be delivered as a regular video stream, depending upon a specific design of the television content delivery and reception system. The term “regular video stream” herein refers to a video stream suitable for the representation in full or in a major area of display screen as a main picture. The term “secondary video stream” herein refers to a video stream suitable for the representation within a limited area of display screen as a sub-picture (generally known as Picture-in-Picture, Picture-out-Picture, etc.) under multi-picture display environment. Secondary video stream herein caries the program contents of which picture quality is lower than the picture quality of a regular video stream. The term “user” and “viewer” are used interchangeably throughout the present application.

Other than the inventive concept, the elements shown in the figures are well known and will not be described in detail. More specifically, familiarity with television broadcasting via radio frequencies (RF)/cable/Internet, television receivers, and video encoding/decoding is assumed and is not described in detail herein. For example, other than the inventive concept, familiarity with current and proposed recommendations for TV standard—such as NTSC (National Television Systems Committee), PAL (Phase Alternation Lines), SECAM (Sequential Couleur Avec Memoire) and ATSC (Advanced Television Systems Committee) (ATSC), Integrated Services Digital Broadcasting (ISDB), Chinese Digital Television System (GB) and DVB-H—is assumed. Likewise, other than the inventive concept, other transmission concepts-such as eight-level vestigial sideband (8-VSB), Quadrature Amplitude Modulation (QAM), and Quadrature Phase-Shift Keying (QPSK)—and receiver components—such as a radio-frequency (RF) front-end (such as a low noise block, tuners, down converters, etc.), demodulators, correlators, leak integrators and squarer—are assumed. Further, other than inventive concept, other video communication concepts—such as IPTV multicast system, bi-directional cable TV system, Internet protocol (IP) and Internet Protocol Encapsulator (WE)—are assumed. Similarly, other than the inventive concept, formatting and encoding/decoding methods—such as Moving Picture Expert Group (MPEG)-2 Systems Standard (ISO/IEC 13818-1) and H.264/MPEG-4 AVC—for generating transport bit streams are well-known and not described herein.

Modern video compression techniques can achieve a very high degree of compression by utilizing the temporal correlation of video frames. In a group of pictures (GOP), only one picture is entirely intra coded and the remaining pictures are encoded wholly or partially based on redundancy shared with other pictures. An intra-coded picture (I) uses only redundancy within itself to produce compression. Inter-coded pictures (B or P pictures), however, must be decoded after the related intra coded picture(s) is/are decoded. Since I pictures typically require 3 to 10 times more bits than a B or P picture, they are encoded much less frequently in the bit stream in order to reduce the overall bit rate. In general, for the same video sequence, a stream encoded with a relatively large number of pictures included within a GOP (e.g. >2 seconds worth of video) has a significantly lower bit rate than the one encoded with a short (e.g., <=1 second worth of video) GOP size.

However, using a GOP size, which is relatively large, has an unintentionally adverse effect on the channel change latency. That is, when a receiver tunes to a video program, the receiver must wait until the first I picture is received before any pictures can be decoded for display. Less frequent I pictures can cause longer delays in a channel change. Most broadcast systems transmit I pictures frequently, for example, every 1 second or so, in order to limit the channel change delay time due to the video compression system. Needless to say, more frequent I pictures significantly increase the overall transmission bitrate.

In the field of digital video multicasting, such as an interactive IPTV multicast systems, the channel change latency, due to the waiting time interval for an Instantaneous Decoder Refresh (IDR) frame in a GOP, has been a troublesome problem to viewers as the problem considerably degrade their overall quality of experience (QoE). As described above, because an IDR frame includes a significantly larger amount of bits to encode than P or B frame, having more frequent IDR frames in a regular video stream is not a desirable solution in consideration of the limitation of the total GOP bitrate.

A potential solution to such a channel change latency problem may be to employ a buffering device within the multicast network system itself in order to buffer the latest portion of the broadcast stream. Then the system unicasts the buffered video contents to a receiver (such as a set-top box), starting from an I picture, when a user sends a channel change request to the multicast system from his/her receiver. Here, the unicast stream may be sent either with a transmission rate faster than the normal bit rate or on the normal transmission bitrate. After an I picture of the buffered stream is received, then the receiver switches back to the broadcast stream corresponding to the buffered video stream.

A remarkable disadvantage of this solution is that the network system requires complex middleware support. Furthermore, the system also requires the necessary hardware to store the unicast streams. As a result, the bandwidth and storage requirement for the multicast network need to be scaled up as a total number of concurrent users increases. Needless to say, this undesirably imposes additional costs on the network providers.

Another solution to the problem is to transmit a channel change stream that includes low-resolution IDR frames more frequently than a regular video stream along with the corresponding regular video stream during a channel change operation as disclosed in the published International Patent Application (WO 2008/013883, entitled “Method and Apparatus for Fast Channel Change for Digital Video”, published 31 Jan. 2008). It is mentioned therein that such a channel change stream may be utilized for broadcasting secondary program contents, such as PIP or POP video contents.

The present application addresses a channel-change latency problem that may occur under multi-picture digital television environment. More specifically, the problem occurs in conjunction with a channel change operation between the program contents of a sub picture (e.g., a PIP picture) and those of a main picture. For example, in a channel change operation, a viewer may attempt to display the program contents of a sub picture currently displayed within a sub-picture window (e.g., a PIP window) in full screen or over a majority of the viewing area of the display screen as a new main picture. For example, in another channel operation, a viewer may attempt to swap the program contents of a sub picture with those of the main picture. Accordingly, there is a need for a method and apparatus that avoids the aforementioned channel-change latency problems and improves the QoE of viewers. The present invention addresses these and/or other issues.

In accordance with an aspect of the present invention, a method is disclosed. According to an exemplary embodiment, the method comprises receiving and decoding a first regular video stream and a secondary video stream, the first regular video stream and the secondary video stream carrying respective ones of first and second program contents; displaying the first program contents and the second program contents simultaneously on a single display screen, the first program contents and the second program contents being different; up-sampling the decoded secondary video stream for replacing the first program contents with the second program contents on the screen in response to a request by a user; receiving and decoding a second regular video stream, the second regular video stream carrying third program contents, the second regular video stream being synchronized with the secondary video stream in a time domain, the third program contents being identical to the second program contents; and replacing the second program contents with the third program contents when an instantaneous decoder refresh (IDR) frame in the second regular video stream is received and decoded.

In accordance with another aspect of the present invention, a device is disclosed. According to an exemplary embodiment, the device comprises means, including at least one video stream receiver and one decoder, for receiving and decoding a first regular video stream and a secondary video stream, the first regular video stream and the secondary video stream carrying respective ones of first and second program contents; means for processing a video signal for displaying the first program contents and the second program contents simultaneously on a single display screen, the first program contents and the second program contents being different; and means, such as a up-sampler, for up-sampling the decoded secondary video stream for replacing the first program contents with the second program contents on the screen in response to a request by a user, wherein the receiving means receives and decodes a second regular video stream, the second regular video stream carries third program contents, the second regular video stream is synchronized with the secondary video stream in a time domain, the third program contents is identical to the second program contents, and the processing means, such as at least one video signal processor, replaces the second program contents with the third program contents when an instantaneous decoder refresh (IDR) frame in the second regular video stream is received and decoded.

In accordance with an aspect of the present invention, a method is disclosed. According to an exemplary embodiment, the method comprises receiving and decoding a first regular video stream for display, the first regular video stream carrying first program contents; requesting the transmission of a secondary video stream and a second regular video stream in response to a first request by a user, the secondary video stream carrying second program contents and the second regular video stream carrying third program contents, the first program contents and the second program contents being different while the second and third program contents being identical, the second regular video stream being synchronized with the secondary video stream in a time domain; receiving and decoding the secondary video stream for displaying the first and second video contents simultaneously on a single display screen; storing at least the latest GOP of the second regular video stream; and decoding the stored second regular video stream for replacing the first program contents with program contents of the cashed second regular video stream on the display screen in response to a second request by a user.

In accordance with another aspect of the present invention, a device is disclosed. According to an exemplary embodiment, the device comprises means, including at least one video stream receiver and one decoder, for receiving and decoding a first regular video stream, the first regular video stream carrying first program contents; and means, such as a memory, for storing digital data, wherein the receiving means sends at least one request command for the transmission of a secondary video stream and a second regular video stream in response to a first request by a user, the secondary video stream carries second program contents and the second regular video stream carries third program contents, the first program contents and the second program contents are different while the second and third program contents are identical, the second regular video stream is synchronized with the secondary video stream in a time domain; the receiving means receives and decodes the secondary video stream for displaying the first and second video contents simultaneously on a single display screen and stores at least the pre-decoded latest GOP packets of the second regular video stream in the storing means; the receiving means decodes the stored second regular video stream for replacing the first program contents with program contents of the cashed second regular video stream on the display screen in response to a second request by a user.

The above-mentioned and other features and advantages of this invention, and the manner of attaining them, will become more apparent, and the invention will be better understood by reference to the following description of embodiments of the invention taken in conjunction with the accompanying drawings, wherein:

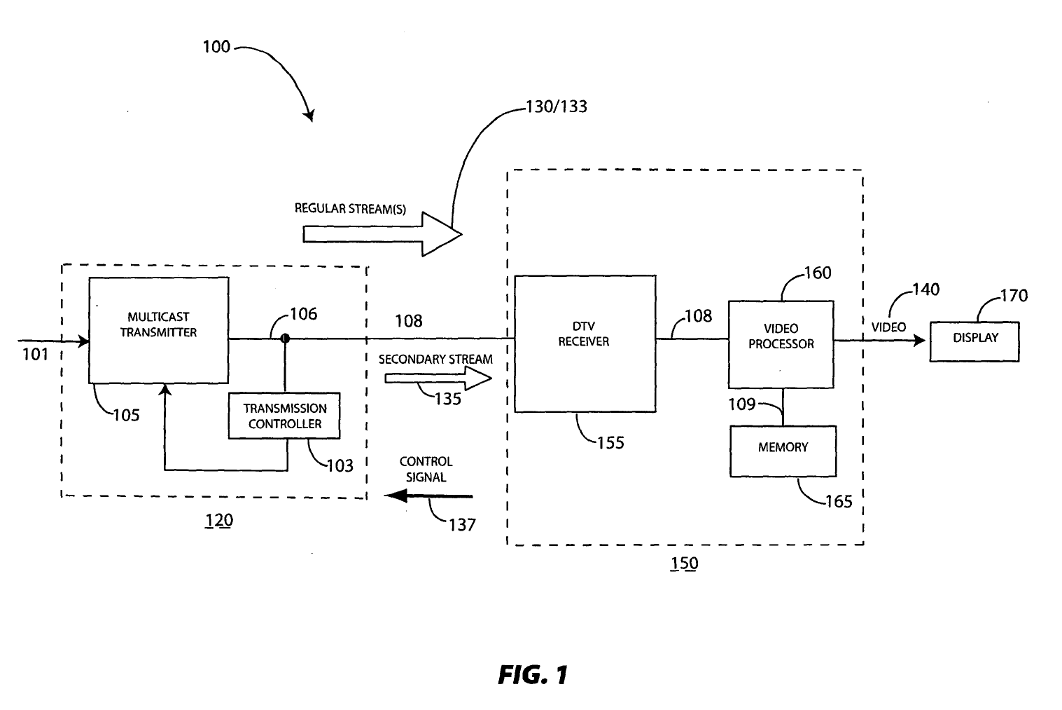

FIG. 1 is a block diagram illustrating exemplary multicast reception system 150 in which the present invention may be implemented;

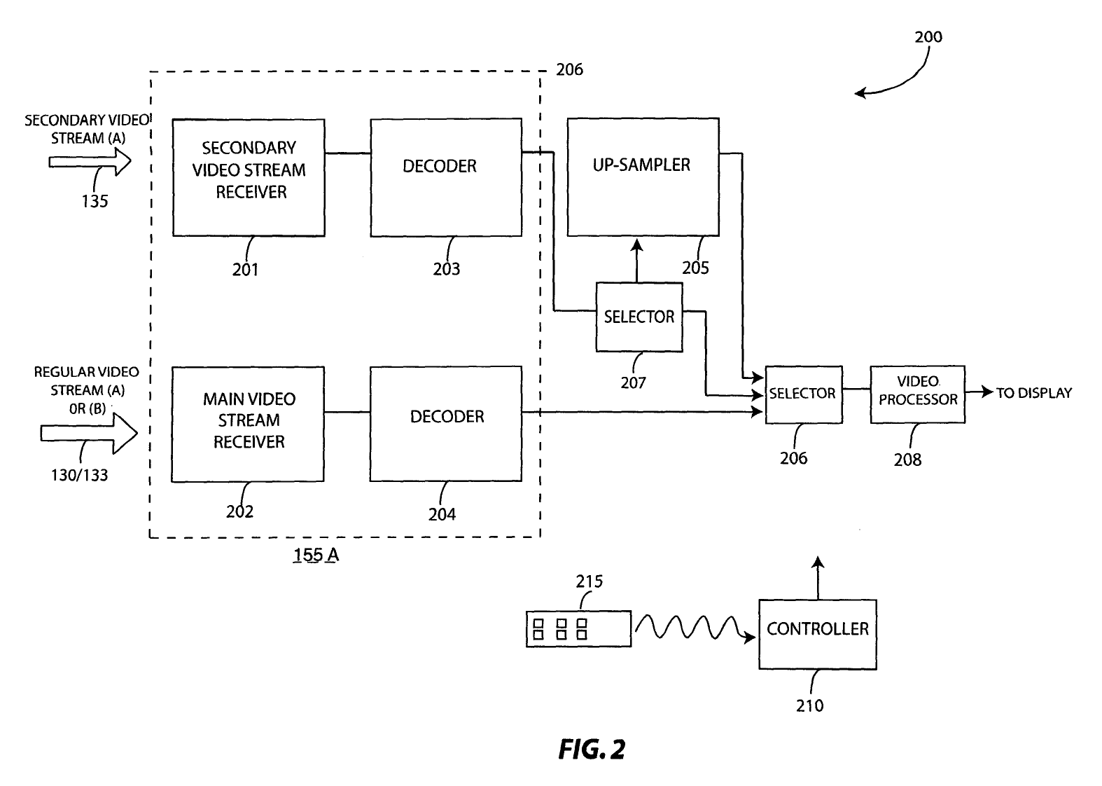

FIG. 2 is a block diagram showing the details of a first exemplary embodiment 155 A of receiver 150 of FIG. 1 in accordance with the principles of the present invention;

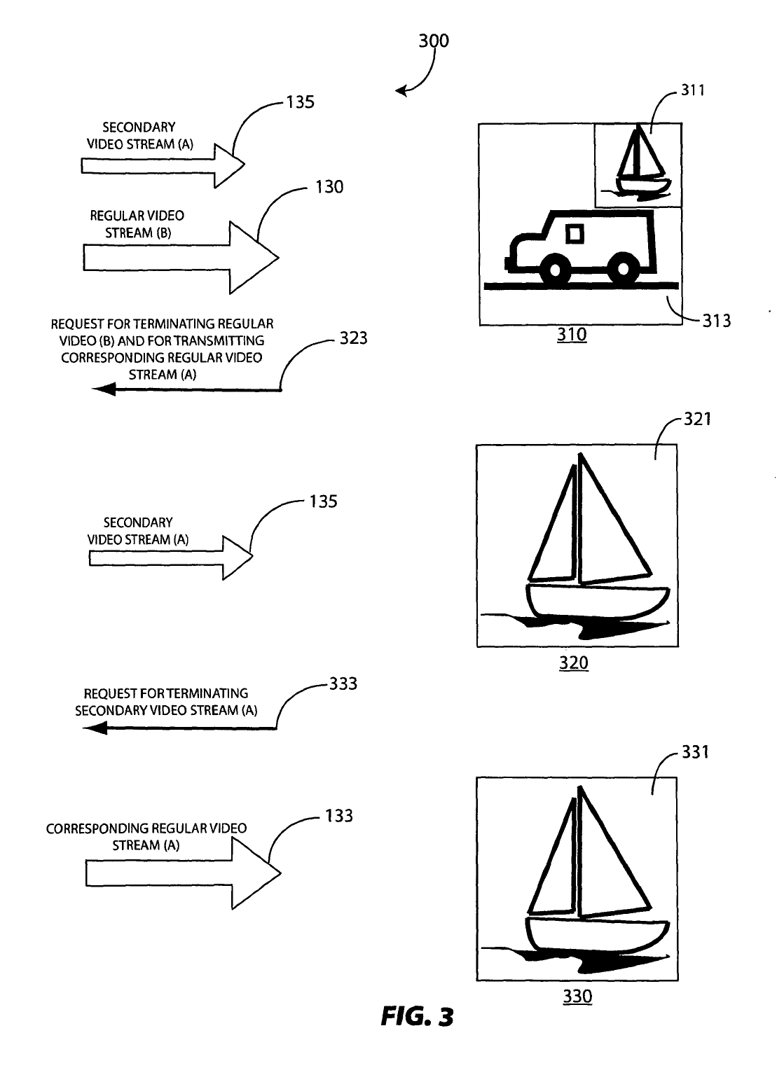

FIG. 3 illustrates a fast channel-change operation of receiver 200 of FIG. 2 in accordance with the principles of the present invention;

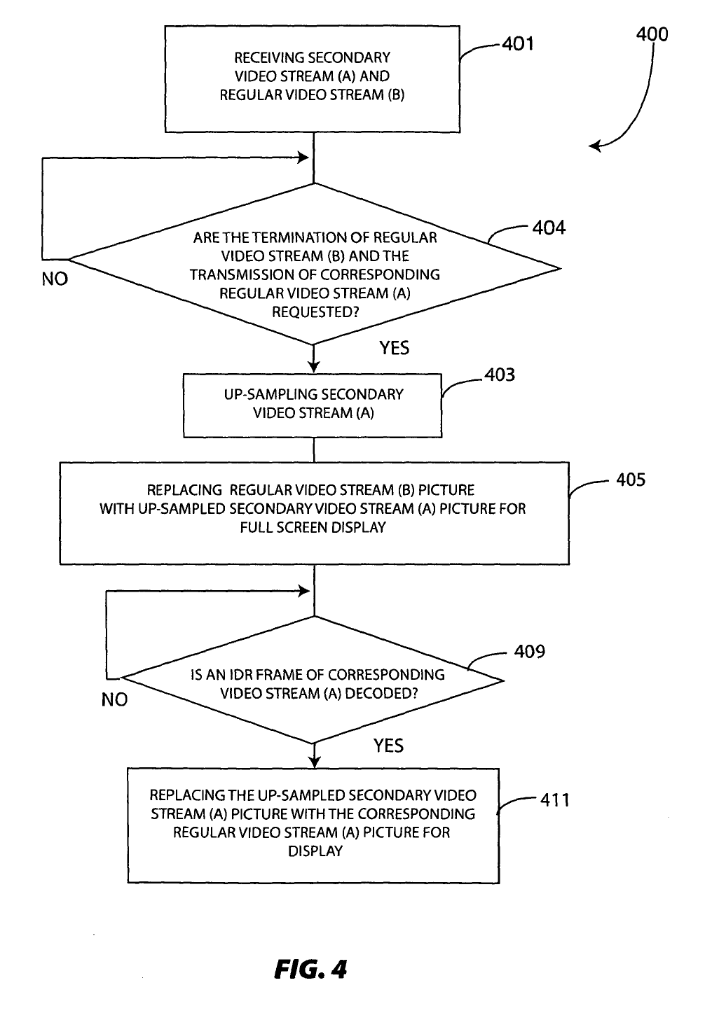

FIG. 4 is a flowchart of steps for the channel-change operation illustrated in FIG. 3 in accordance with the principles of the present invention;

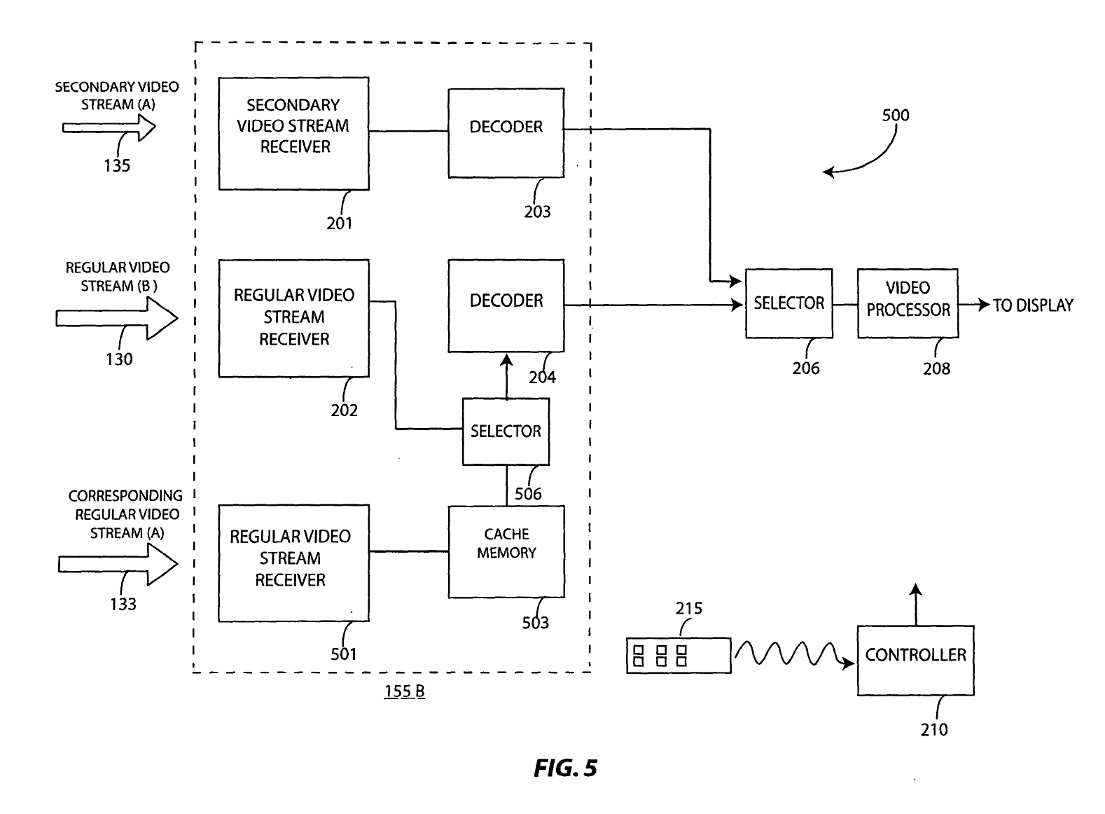

FIG. 5 is a block diagram showing the details of a second exemplary embodiment 155 B of receiver 150 of FIG. 1 in accordance with the principles of the present invention;

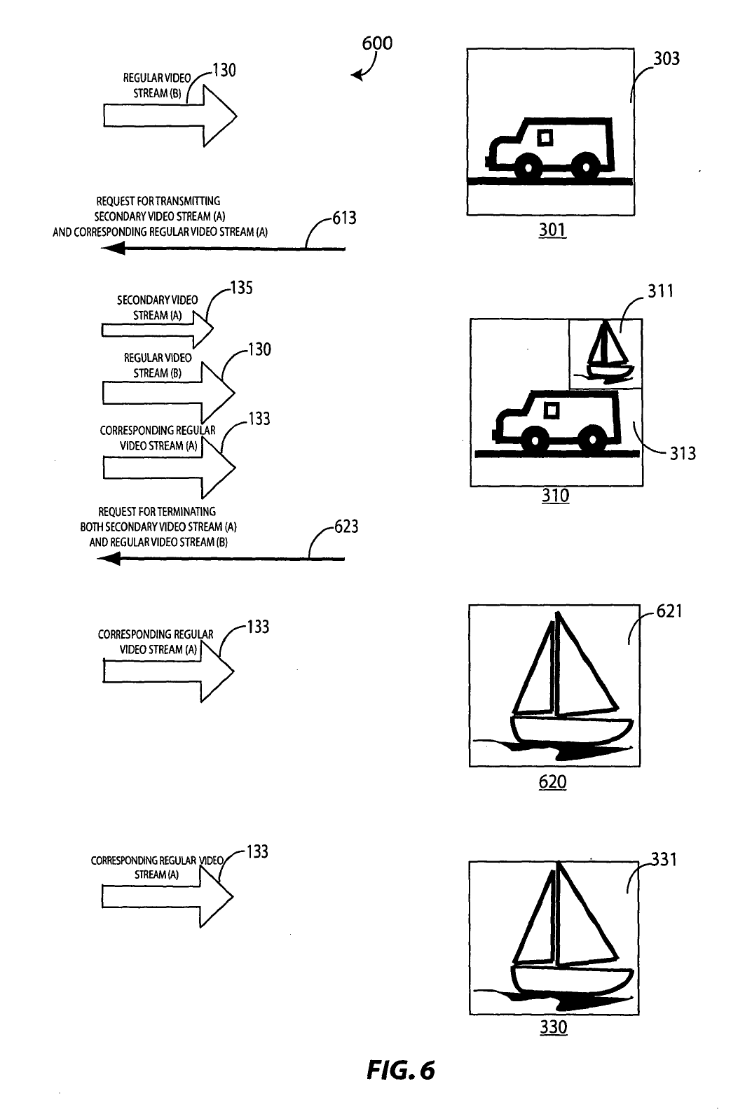

FIG. 6 illustrates a fast channel-change operation of receiver 500 of FIG. 5 in accordance with the principles of the present invention;

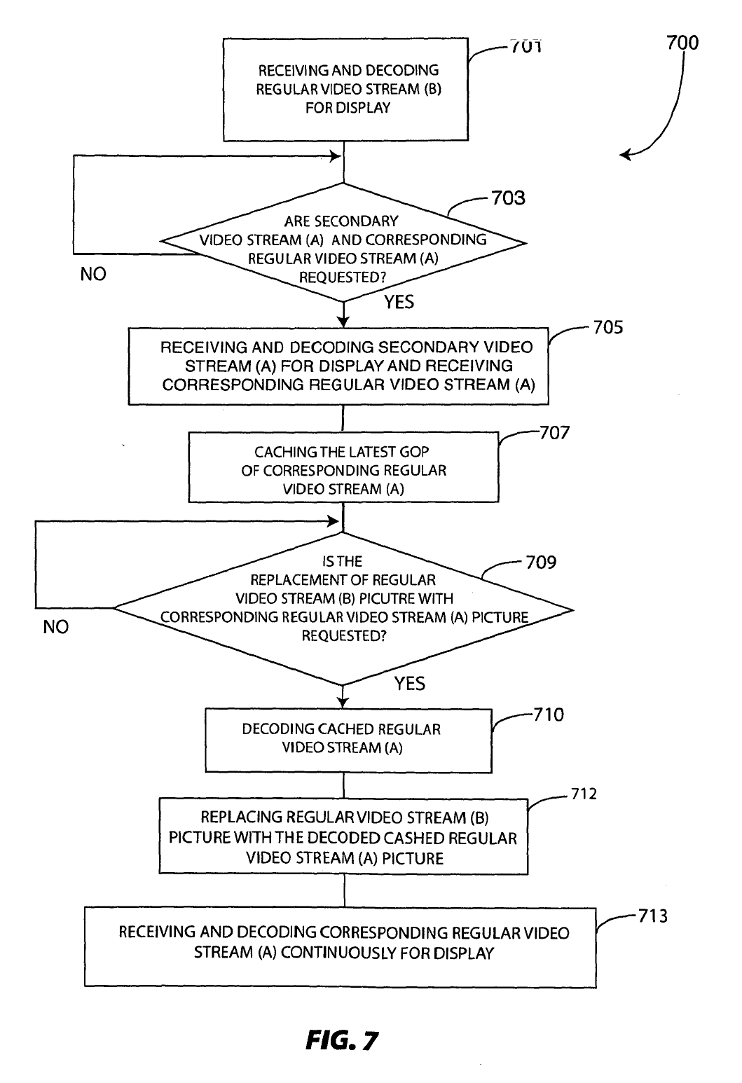

FIG. 7 is a flowchart of steps for the channel-change operation illustrated in FIG. 6 in accordance with the principles of the present invention; and

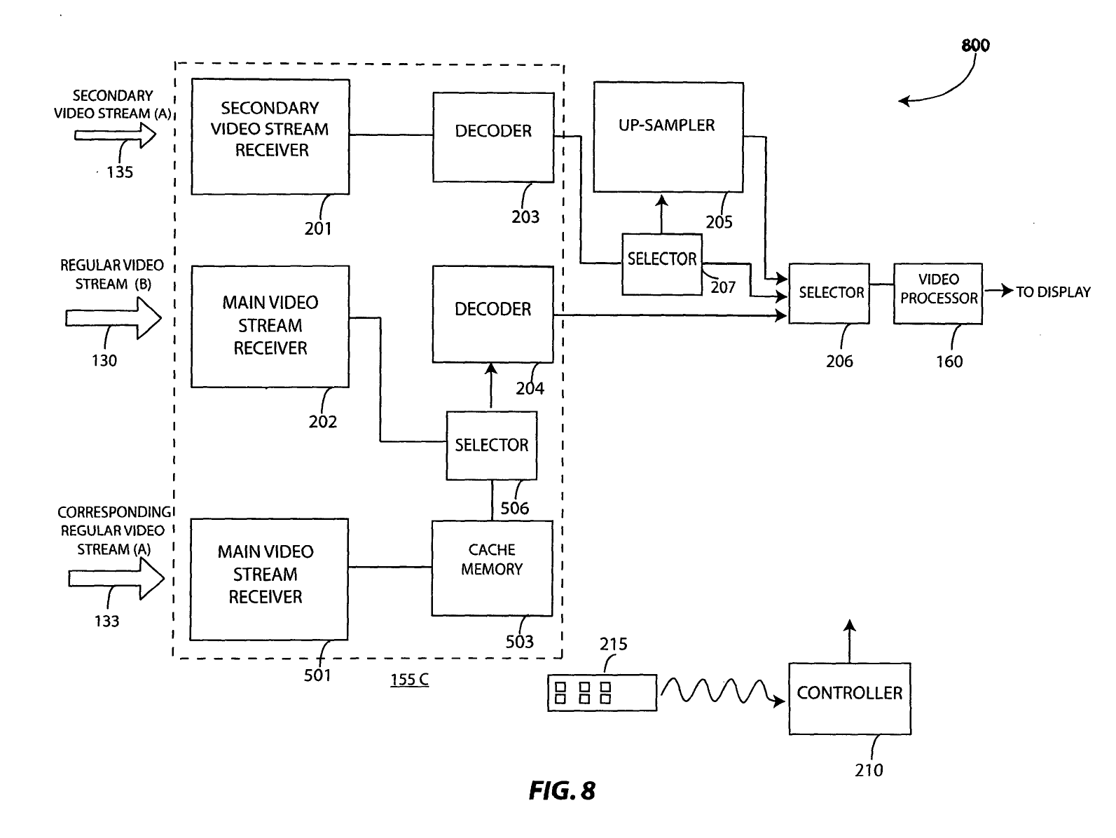

FIG. 8 is a block diagram showing the details of a third exemplary embodiment 155 C of receiver 150 of FIG. 1 in accordance with the principles of the present invention.

The present principles are directed to a method and apparatus for fast channel change between a sub picture and a main picture under multi-picture display digital television environment. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions. In the drawings, like-numbers on the figures represent similar elements.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future—i.e., any elements developed that perform the same function, regardless of structure.

Thus, for example, it will be appreciated by those skilled in the art that the block diagrams presented herein represent conceptual views of illustrative system embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Similarly, when provided by a memory, the functions may be provided by a single dedicated memory chip or module, by a single shared memory chip or module, or by a plurality of individual memory chips or modules, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches or selectors shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, (i) a combination of circuit elements that performs that function or (ii) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

It is to be appreciated that while one or more embodiments of the present principles are described herein with respect to a switched network, such as fiber or Digital Subscriber Line (DSL) based Internet Protocol Television (IPTV) network, where a secondary video stream for a sub picture is delivered to the multicast fork point, such as a Digital Subscriber Line Access Mutliplexer (DSLAM) or a switch, the present principles are not limited solely to such switched systems and, thus, may be used with respect to any media transmission system that uses a transport stream including, but not limited to, MPEG-2 transport streams. Thus, for example, the present principles may be utilized with respect to cable television systems, satellite television systems, and so forth, while maintaining the spirit of the present principles.

The present invention described herein addresses various issues related to fast channel-change operations in which a multiple video program display system, such as a multicast Picture-in-Picture (PIP) system, is involved. For purposes of example and explanation, the principles of the present invention will be described with specific reference to a multicast Picture-in-Picture (PIP) television signal receiving system with or without a display. However, it will be intuitive to those skilled in the art that the principles of the present invention may also be applied to, and implemented in, other types of multiple video program display system, including Picture-out-Picture (POP) system, as well as in other types of interactive video distribution systems, including systems that employ wired and/or wireless signal transmission.

As described above, the channel-change latency is a significant problem in the field of digital video reception nowadays. The problem arises due to the undesirable time internal in which a receiver waits for an IDR frame of the newly selected video program to come.

In a multicast video distribution network, a channel-change process starts with a request to join a multicast group. Then the video decoder tunes into that particular group, waiting for the first IDR frame in a GOP of the selected video stream. The delay of this process, therefore, mainly depends on the frequency of the IDR frames. For example, if an IDR frame appears once every 48 frames in a GOP for a typical 24 fps frame rate stream, since the decoder could start receiving the first frame in any frame of the GOP, all the previous frames prior to the first IDR frame of the GOP has to be discarded. As a result, the channel change latency can be as long as 2 seconds.

With respect to a multi-picture television system, a user can display both a main picture and a sub-picture (e.g., a PIP picture) simultaneously on a single display screen. Here, a user often replaces the main channel to the PIP channel to bring the program contents of the PIP channel to full screen. Since a secondary video stream for the PIP channel is usually not associated with any channel change methods in the existing services, a typical PIP stream is just a low-resolution video stream that may have the same number of IDR frames as regular video streams. Here, the channel change latency problem occurs when a user attempts to change the main picture channel to any one of other channels available, including the PIP channel. Furthermore, since a secondary video stream for the PIP channel may not be synchronized in a time domain with the corresponding regular stream which carries the PIP program contents, the PIP picture cannot be brought up to the main or full screen area seamlessly. That is, undesirable artifacts may be shown during the channel change. A secondary video stream for a PIP picture and its corresponding regular video stream for a main picture are separate IP streams with 30 different multicast addresses. These two streams are usually not related when being encoded and transported.

The present invention teaches taking advantage of then-available PIP stream to fill up the undesirable channel-change interval. In order for a receiver to receive an IDR frame of the secondary video stream before receiving an IDR frame of its corresponding regular video stream, the secondary video stream is designed to have more IDR frames periodically than the corresponding regular stream (i.e., the length of GOP of the PIP stream is shorter than that of the corresponding regular video stream). For example, a PIP stream has one IDR frame in every 12 frames (GOP=0.5 second) while the corresponding regular stream has one IDR frame in every 48 frames (GOP=2 second). In addition, in order to accomplish a seamless transition from the secondary video stream to the corresponding regular video stream, these two streams are synchronized in a time domain. For example, the synchronization may be obtained by assigning the same presentation time stamps for the corresponding regular and PIP frame.

More specifically, the present application discloses two methods for the fast and seamless channel change herein. The first method is to up-sample and display the then-available secondary video stream for a PIP picture while a receiver keeps waiting for an IDR frame of the corresponding regular video stream. That is, the contents of the up-sampled secondary video stream are displayed during the undesirable channel-change delay interval. Once the IDR frame in the corresponding regular channel is received and decoded, the up-sampled PIP frame is switched to the corresponding regular video frame.

Due to the time synchronization between the secondary and corresponding regular video streams, the transition from the up-sampled PIP frame to the corresponding regular video frame on the screen is accomplished substantially seamlessly. In other words, substantially no undesirable artifacts may be seen during the channel change. Here, undesirable artifacts may include a jittering of frames, such as duplicated pictures and/or a frozen screen due to the loss of frames. This seamless transition improves the QoE of viewers in addition to the fast channel change.

As a result, the channel change delay can be reduced significantly (for example, from an undesirable amount of delay of 2.0 seconds to a tolerable amount of delay of 0.5 seconds). Although the quality of the up-sampled PIP picture displayed during the channel change interval may not be as good as that of the picture derived from the corresponding regular video stream, because of the original picture quality of the secondary video stream, showing a qualitatively inferior up-sampled PIP frame is undoubtedly a better solution to viewers rather than showing frozen or black screen with a slow channel-change experience.

The second method disclosed herein is to send a request command(s), upon the initiation of PIP operation by a user, to the multicast system, requesting the transmission of both a secondary video stream for a PIP picture and the corresponding synchronized regular video stream altogether. As a result, at least one secondary video stream and two regular video streams—i.e., one regular video stream for a main picture and another regular video stream for the PIP contents—become available for the receiver. Then the receiver stores all the packets of the latest GOP of the corresponding regular video stream without decoding. This makes the latest GOP data become always available for the prospective channel change of the main picture to the PIP channel.

As soon as a user initiates the channel-change operation, the receiver immediately decodes the cached GOP of the corresponding regular video stream for display during the channel-change interval. The transition from the PIP picture to the video contents of the cached GOP is done substantially seamlessly since the secondary video stream is time synchronized to its corresponding regular video stream. The receiver then continues to decode the following GOPs of the corresponding regular video stream for display.

The beauty of this method is that no additional decoding power is required to the receiver because the last GOP data of the corresponding regular video stream is cached without being decoded. Additional network bandwidth is necessary to receive the three video streams simultaneously.

Here, it is possible to incorporate the first method into the second method. More specifically, the receiver can up-sample the secondary video stream for display during the channel-change interval. Then the up-sampled PIP picture is replaced by the corresponding picture derived from the decoded cashed GOP data of the corresponding regular video stream. Such a transition is also done substantially seamlessly since the second video stream for the PIP picture is time synchronized with the corresponding regular video stream. In this combined method, the switching speed from the up-sampled PIP picture to the corresponding picture derived from the cached corresponding regular stream significantly increases where the receiver has adequate computing power. Again, the seamless switching is obtained due to the time-synchronization between the two corresponding streams.

Referring now to the drawings, and more particularly to FIG. 1, an exemplary configuration 100 to which the present principles may be applied is shown. In particular, the exemplary configuration of FIG. 1 includes multicast equipment 120, receiver 150, and bi-directional digital signal communication path 108 coupled therebetween. Multicast equipment 120 includes multicast transmitter 105 and transmission controller 103, which controls multicast transmitter 105 in response to control signal 137 sent by receiver 150. Receiver 150 is a processor-based system, including DTV receiver 155, video processor 160, and memory 165. Receiver 150 may or may not include display 170 (e.g., cell phone, mobile TV, set top box, digital TV (DTV), etc.).

Receiver 150 communicates with multicast equipment 120. More specifically, multicast transmitter 105 receives signal 101 and provides multicast signal 106 for receiver 150 in response to control signal 137 generated by receiver 150. Then receiver 150 receives multicast signal 106 via bi-directional digital signal communication path 108 in accordance with the principles of the present invention. Receiver 150 processes received multicast signal 106 in accordance with the principles of the present invention and provides an output video signal 140 for display 170.

Signal communication path 108 may be formed by at least a single wired, optical, or wireless digital signal communication path or any combination of thereof. Such a communication path may be made of a combination of a plurality of uni-directional signal paths and/or a single or a plurality of bi-directional signal paths. Multicast signal 106 includes at least one of regular video streams 130, 133, which includes at least one digital video stream with normal picture quality and secondary video stream 135, which includes at least one digital video stream with less picture quality. Receiver 150 sends control signal 137 in a form of digital command, commands or any combination thereof to multicast equipment 120. Transmission controller 103 controls multicast transmitter 105 in response to control signal 137 so that multicast transmitter 105 may transmit a particular video stream, streams, or any combination thereof to receiver 150 in response to a request(s) made by a viewer.

As to a Picture-in-Picture (PIP) operation, PIP program contents A are transmitted as secondary video stream (A) 135 while main picture contents B are transmitted as regular video stream (B) 130. The parenthesized letter A and B represents different program contents carried by each one of the video streams throughout the present application. Here, in order to accomplish a fast and seamless channel change to PIP program contents in accordance with the principles of the present invention, secondary video stream (A) 135 and the corresponding regular video stream (A) 130 exhibit the following characteristics: (i) secondary video steam (A) 135 and its corresponding regular video stream (A) 130 have the identical program contents; (ii) secondary video steam (A) 135 has more IDR frames periodically than its corresponding regular video stream (A) 130; (iii) secondary video stream (A) 135 may be transmitted with less transmission bandwidth (e.g., PIP pictures may be encoded for lower bitrate for lower resolution) on signal communication path 108 than that required for its corresponding regular video stream (A) 130—the bandwidth differences are represented by the different sizes of arrows 130/133 and 135 in FIG. 1; and (iv) secondary video stream (A) 135 and its corresponding regular video stream (A) 130 are synchronized in a time domain.

The beauty of this system is that when the channel-change operation is initiated by a user, receiver 150 needs not to request any channel-change stream from multicast equipment 120 for the fast channel-change operation since then-available secondary video stream 135 functions as a channel-change stream. This speeds up the overall channel-change operation. Receiver 150 needs only to request, in the form of appropriate multicast “join” command(s), the transmission of corresponding regular video stream (A) and the termination of regular video stream (B). This channel change operation and associated signal flows are described in detail below with respect to FIG. 3.

Although FIG. 1 describes an exemplary implementation of the present invention in conjunction with a switched network, such as fiber or Digital Subscriber Line (DSL) based Internet Protocol Television (IPTV) network, where the secondary video stream is delivered to the multicast fork point, such as a Digital Subscriber Line Access Mutliplexer (DSLAM) or a switch, the principles of the present invention may also be implemented in a non-switched network, such as cable (e.g., HFC) or satellite broadcast, where the secondary stream is delivered to a receiver all times.

Of course, it is to be appreciated that the present principles are not limited to solely these foregoing two implementations regarding the delivery of the secondary video stream for a sub picture and, given the teachings of the present principles provided herein, one of ordinary skill in this and related arts will contemplate these and various other options regarding the delivery of secondary video stream while maintaining the spirit of the present principles.

Referring now to FIG. 2, a block diagram showing the details of a first exemplary embodiment of receiver 150 of FIG. 1 in accordance with the principles of the present invention is shown. For purposes of example and explanation, FIG. 2 will be described with reference to the previously described elements of FIG. 1. Secondary video stream (A) 135 is received by secondary video stream receiver 201, and each one of regular video streams (B) 130 and (A) 133 is received by regular video stream receiver 202 at a different time of the operation of receiver 200. These two regular streams carry different program contents A and B, and the program contents of regular video stream (A) 133 are identical to those of secondary video stream (A) 135. Furthermore, as described above, secondary video stream (A) 135 is time-synchronized with corresponding regular video stream (A) 133.

The received secondary video stream (A) 135 is decoded by decoder 203 while the received regular video stream (B) is decoded by decoder 204. Here those of skilled in the art will recognize that receivers 201, 202 and decoders 203, 204 can be embodied in a single receiver module 155 A as indicated by the dotted lines in FIG. 2.

As soon as the PIP operation is initiated by a viewer via remote controller 215, the output signal of decoder 203 is applied to up-sampler 205, via selector 207, where the secondary video stream (A) 135 is up-sampled so that relatively lower quality PIP pictures of video stream (A) 135 may be displayed in an area larger than the area where a PIP picture is normally display on video display 170 (i.e., a PIP window)—such as the entire viewing area of the video display screen. The up-sampling is performed during the channel-change interval. The program contents of the up-sampled secondary video stream (A) 135 is being displayed until corresponding regular video stream 133 is received and decoded for display. Here, controller 210, including at least one microprocessor and memory, controls the entire operation of receiver 200, communicating with the various devices associated with receiver 200, including selectors 206, 207 and remote controller 215, in an ordinary manner known to one skilled in the art.

Once the first IDR frame of the corresponding regular stream 133 (A) is received and decoded, selectors 206 establishes a signal path between decoder 204 and video processor 208 while decoupling the signal path between up-sampler 205 and video processor 208. Due to the time-synchronization between secondary video stream 135 (A) and corresponding regular video stream 133 (A), the program contents of the up-sampled secondary video stream is replaced with those of corresponding regular video stream 133 (A) substantially seamlessly. Again, those of skill in the art will recognize up-sampler 205 and selectors 206, 207 can be implemented in various forms of video switching devices controlled by controller 210.

Thus, as described above, while secondary video stream 135 (A) is being viewed during the channel-change interval, secondary video stream 135 (A) is up-sampled so that secondary video stream 135 (A) may be displayed over a screen area larger than the PIP window. The up-sampled regular video signal is displayed while receiver 200 waits for the first IDR frame of corresponding regular stream (A) 133. Once the first IDR frame is received and decoded, selector 206 switches to corresponding regular video stream 133 (A).

Referring now to FIG. 3, a fast channel change operation of receiver 200 of FIG. 2 in accordance with the principles of the present invention is shown. For purposes of example and explanation, FIG. 3 will be described with reference to the previously described elements of FIGS. 1 and 2. More specifically, each one of pictures 310, 320 and 330 illustrates a screen view at a different step of the channel-change operation. Arrows 130, 133, 135, 323, and 336 indicate the signal communications between multicast equipment 120 and receiver 200. Each one of the arrows indicates a specific direction of signal flow between multicast equipment 120 and receiver 200, and three different arrow sizes indicate the relative bandwidths required for their transmission on bi-directional digital signal communication path 108. The program contents of video program A is represented by a sailing boat picture while those of video program B is represented by an automobile picture in FIG. 3.

Picture 310 illustrates a screen view of video display 170 when two different video programs A and B are displayed simultaneously under multi-picture display environment. Sub picture 311, representing video program A, is displayed within a relatively small area of the screen (i.e., PIP window) while main picture 313, representing video program B, is displayed in a larger area of the screen (i.e., main picture area). Sub picture 311 is derived from secondary video stream (A) 135 while main picture 313 is derived from regular video stream (B) 130.

In response to a channel-change request(s) made by a viewer with remote controller 215, receiver 200 sends control command 323 as control signal 137 to multicast equipment 120, requesting the termination of regular video stream (B) 130 and transmission of corresponding regular video stream (A) 133.

Picture 320 illustrates a screen view of video display 170 during the channel-change interval, where the program contents of up-sampled secondary video stream (A) 135 is displayed in full screen.

As soon as the first IDR frame of corresponding regular video stream is received and decoded, receiver 200 sends a control commands) 333 to multicast equipment 120, as control signal 137, requesting the terminating of secondary video stream (A) 135. Since secondary video stream (A) 135 and corresponding regular video stream (A) 133 are synchronized in a time domain, the program contents of secondary video stream (A) 135 is replaced with those of corresponding regular video stream (A) 133 substantially seamlessly.

Referring now to FIG. 4, a flowchart of steps for the channel-change operation described in FIG. 3 is shown in accordance with the principles of the present invention. For purposes of example and explanation, the steps of FIG. 4 will be described with reference to the previously described elements of FIGS. 1, 2 and 3. The steps of FIG. 4 are exemplary only, and are not intended to limit the present invention in any manner.

The method 400 starts with step 401 where secondary video stream receiver 201 and regular video stream receiver 202 receive secondary video stream (A) 135 and regular video stream (B) 130, respectively. Here the program contents of secondary video stream (A) 135 are displayed within a PIP window as a sub picture while those of regular video stream (B) 130 are displayed in a main picture area as a main picture as shown in picture 310 of FIG. 3.

At step 404, receiver 200 determines whether a viewer makes a request for the channel change (i.e., watching the video program A currently displayed in the PIP window as a sub picture as a full screen main picture). As soon as such a request is made, receiver 200 sends a request command(s) 613, as control signal 137, to multicast equipment 120, requesting the termination of regular video stream (B) and the transmission of corresponding regular video stream (A).

At step 403, up-sampler 205 up-samples the output signal of decoder 203 so that the program content of secondary video stream (A) 135 may be displayed immediately in full screen. At step 405, the program contents of regular video stream (B) 130 are replaced with those of secondary video stream (A) 135 as illustrated with screen view 320 of FIG. 3. At step 409, receiver 200 determines whether an IDR frame of corresponding regular video stream (A) 133 is received and decoded. At step 411, as soon as the IDR frame is decoded, receiver 200 replaces the program contents of up-sampled secondary video stream (A) 135 with those of corresponding regular video stream (A) 133 substantially seamlessly as illustrated with screen view 330 of FIG. 3.

Thanks to the time synchronization between secondary video stream (A) 135 and corresponding regular video stream (A) 133, the switching from the program contents of up-sampled secondary stream (A) 135 to those of corresponding regular video stream 133 may be done seamlessly. Those of skill in the art will recognize that without this synchronization, a viewer may see an undesirable jittering of frames during the channel-change interval—e.g., seeing duplicated pictures or a frozen screen due to loss of frames. This seamless switching operation significantly improves the QoE of a viewer.

Using the method of FIG. 4, the channel change delay can be reduced significantly (for example, from an undesirable amount of delay of 2.0 seconds to a tolerable amount of delay of 0.5 seconds). Although the picture quality of the program contents of the up-sampled secondary stream may not be seen as good as that of the program contents of corresponding regular video stream (A) 133, those of skilled in the art will appreciate that seeing the program contents of the up-sampled secondary video stream is much better than being annoyed with a slow channel-change operation with frozen or black screen from a viewer's point of view.

Referring now to FIG. 5, a block diagram describing the details of a second exemplary embodiment of receiver 150 of FIG. 1 in accordance with the principles of the present invention is shown. For purposes of example and explanation, FIG. 5 will be described with reference to the previously described elements of FIG. 1.

In response to the initiation of PIP operation by a viewer, receiver 500 starts receiving secondary video stream (A) 135 and two regular video streams—i.e., regular video stream (B) 130 and regular video stream (A) 133—simultaneously. During the PIP operation, two video streams—i.e., secondary video stream (A) 135 and regular video stream (B) 130—are decoded by respective ones of decoders 203 and 204 for display while all the un-decoded packets of the latest GOP of corresponding regular video stream 133 are stored in cache memory 503. This makes the latest GOP data become always available for the fast channel-change operation of the main picture to the PIP channel.

When a viewer initiates the channel-change operation with remote controller 215, selector 506 establish a signal path between cache memory 503 and decoder 204 while de-coupling the signal path between main video receiver 202 and decoder 204. At the same time, selector 206 provides a signal path between decoder 204 and video processor 208. As a result, the stored GOP packets are decoded and displayed immediately. Then regular video stream receiver 501 continuously provides corresponding regular video stream (A) 133 for decoder 204 through cache memory 503 for display. As described above in conjunction of FIG. 2, controller 210, including at least one microprocessor and memory, controls the entire operation of receiver 500, communicating with the various devices associated with receiver 500, including selectors 206, 506 and remote controller 215, in an ordinary manner known to one skilled in the art.

The beauty of this method is that no additional decoding power is required to receiver 500. This is because the last GOP data of the corresponding regular video stream is stored in cache memory 503 before being decoded. Here those of skilled in the art will recognize that receivers 201, 202, 501 and decoders 203, 204 along with selector 506 and cache memory 503 can be embodied in a single receiver module (e.g., DTV receiver 155) as indicated by the dotted lines in FIG. 5. In addition, unlike the first embodiment, receiver 500 need not wait for the first IDR frame. This arrangement may particularly be suitable for the multicast system with sufficient bandwidth since at least three video streams are received simultaneously as described above.

Due to the time synchronization between secondary video stream (A) 135 and corresponding video stream (A) 133, the replacement of the program contents of secondary video stream (A) 135 and those of the cashed corresponding regular video stream (A) may be performed substantially seamlessly. Again, those skilled in the art will recognize that selectors 206, 506 can be formed with various types of video switching devices controllable by controller 210.

Referring now to FIG. 6, a fast channel change operation of receiver 500 of FIG. 5 in accordance with the principles of the present invention is shown. For purposes of example and explanation, FIG. 6 will be described with reference to the previously described elements of FIGS. 1 and 5.

More specifically, each one of pictures 303, 310, 320 and 330 illustrates a screen view at a different step of the channel-change operation. Arrows 130, 133, 135, 613, and 623 indicate the signal communications between multicast equipment 120 and receiver 500. Each one of the arrows indicates a specific direction of signal flow between multicast equipment 120 and receiver 500, and three different arrow sizes indicate the relative bandwidths required for their transmission on bi-directional digital signal communication path 108. Similar to FIG. 3, the program contents of video program A is represented by a sailing boat picture while those of video program B is represented by an automobile picture in FIG. 6.

Picture 301 illustrates a screen view of video display 170 when the program contents of regular video stream (B) 130 are displayed as a main picture. Upon the initiation of the PIP operation—i.e., a viewer requests to display the program contents of secondary video stream (A) in a PIP window as a sub picture—receiver 500 sends a request command(s) to multicast equipment 120, requesting the transmission of secondary video stream (A) 135 and corresponding of regular video stream (A).

Picture 310 illustrates a screen view of video display 170 when two different video programs A and B are displayed simultaneously under multi-picture display environment. Sub picture 311, representing video program A, is displayed within a relatively small area of the screen (i.e., PIP window) while main picture 313, representing video program B, is displayed in a larger area of the screen (i.e., main picture area). Sub picture 311 is derived from secondary video stream (A) 135 while main picture 313 is derived from regular video stream (B) 130.

During the PIP operation, two video streams—i.e., secondary video stream (A) 135 and regular video stream (B) 130—are decoded by respective ones of decoders 203 and 204 for display while all the pre-decoded packets of the latest GOP of corresponding regular video stream 133 are stored in cache memory 503. This makes the latest GOP data become always available for the fast channel-change operation of the main picture to the PIP channel.

In response to a channel-change request(s) made by a viewer with remote controller 215, receiver 500 sends a control command(s) 623 as control signal 137 to multicast equipment 120 as described in FIG. 1, requesting the termination of both regular video stream (B) 130 and secondary video stream (A) 135.

Picture 620 illustrates a screen view of video display 170 during the channel-change interval, where the program contents of the cached GOP of corresponding video stream (A) 133 is displayed in full screen. Then regular video stream receiver 501 continuously provides the following GOPs of corresponding regular video stream (A) 133 for decoder 204 through cache memory 503 as represented by picture 330.

Although the program contents of PIP window are displayed in full screen with respect to the foregoing exemplary embodiment, it is not required that the program contents of PIP window be displayed in full screen. For example, receiver 500 can be designed to swap program contents of PIP window 311 with those of the main picture 313.

Referring now to FIG. 7, a flowchart of steps for the channel change operation illustrated in FIG. 6 in accordance with the principles of the present invention is shown. For purposes of example and explanation, the steps of FIG. 7 will be described with reference to the previously described elements of FIGS. 1, 5 and 6. The steps of FIG. 7 are exemplary only, and are not intended to limit the present invention in any manner.

The method 700 starts with step 701 where regular video stream (B) 130 is received by regular video stream receiver 202 and decoded by decoder 204 for display as represented with picture 301 in FIG. 6.

At step 703, receiver 500 determines whether or not a viewer requests the PIP operation. As soon as the viewer initiates the PIP operation, receiver 500 sends a request command(s) 613 to multicast equipment 120, as control signal 137, requesting multicast equipment 120 to transmit both secondary video stream (A) for a PIP picture and corresponding regular video stream (A) for a main picture, of which program contents are identical to those of secondary video stream (A).

At step 705, secondary video stream receiver 201 and regular video stream receiver 501 of receiver 500 receive respective ones of secondary video stream (A) 135 and regular video stream (A), and decoder 230 decodes received secondary video stream (A) 135 for a PIP picture while decoder 202 decodes received regular video stream (B) for a main picture. The screen view is represented with picture 310 in FIG. 6.

At step 707, receiver 500 caches the latest GOP of corresponding regular video stream (A) 133, and at step 709, receiver 500 determines whether the channel change operation is requested by a viewer (i.e., whether a viewer requests the program contents of PIP window to be displayed full on screen).

At step 710, upon the initiation of the channel-change operation by a viewer, the cached latest GOP of corresponding regular video stream (A) is decoded by decoder 504 via selector 506 for immediate display as illustrated picture 620 of FIG. 6.

At step 712, the program contents of regular video stream (B) 130 is replaced with those of the latest GOP of corresponding regular video stream (A) 133 on the screen. Since secondary video stream (A) 135 is synchronized with corresponding regular video stream (A) 133 in a time domain, this transition is made substantially seamlessly.

At step 713, decoder 504 continues to decode the following GOPs of corresponding regular video stream (A) 133 for display as illustrated with picture 330 of FIG. 6.

Referring now to FIG. 8, a block diagram showing the details of a third exemplary embodiment of receiver 150 of FIG. 1 in accordance with the principles of the present invention is shown. Receiver 800 is a combination of the features disclosed with respect to the two foregoing exemplary embodiments of FIGS. 2 and 5. The detailed operations of receiver 800 should be well understood in conjunction with those of receivers 200 and 500 of FIGS. 2 and 5 described in great detail above and, therefore, is not further discussed.

All the features and advantages of the present principles may be readily ascertained by one ordinary skilled in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one ordinary skilled in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method comprising the steps of:
receiving and decoding a first regular video stream and a secondary video stream, said first regular video stream and said secondary video stream carrying respective ones of first and second program contents;
displaying said first program contents and said second program contents simultaneously on a single display screen, said first program contents and said second program contents being different;
up-sampling said decoded secondary video stream for replacing said first program contents with said second program contents on said screen in response to a request by a user;
receiving and decoding a second regular video stream, said second regular video stream carrying third program contents, said second regular video stream being synchronized with said secondary video stream in a time domain, said third program contents being identical to said second program contents; and
replacing said second program contents with said third program contents when an instantaneous decoder refresh (IDR) frame in said second regular video stream is received and decoded.

2. The method of claim 1 wherein:
a length of the group of pictures (GOP) of said secondary video stream is shorter than a length of the GOP of said first regular video stream

3. An apparatus comprising:
a receiver including at least one video stream receiver and one decoder for receiving and decoding a first regular video stream and a secondary video stream, said first regular video stream and said secondary video stream carrying respective ones of first and second program contents;
a video processor for generating a video signal for displaying said first program contents and said second program contents simultaneously on a single display screen, said first program contents and said second program contents being different; and
an up-sampler, for up-sampling said decoded secondary video stream for replacing said first program contents with said second program contents on said screen in response to a request by a user, wherein:
said receiver receives and decodes a second regular video stream, said second regular video stream carries third program contents, said second regular video stream is synchronized with said secondary video stream in a time domain, said third program contents are identical to said second program contents and
said video processor replaces said second program contents with said third program contents when an instantaneous decoder refresh (IDR) frame in said second regular video stream is received and decoded.

4. The apparatus of claim 2 wherein:
a length of the group of pictures (GOP) of said secondary video stream is shorter than a length of the GOP of said first regular video stream.

5. An apparatus comprising:
means for receiving and decoding a first regular video stream and a secondary video stream, said first regular video stream and said secondary video stream carrying respective ones of first and second program contents;
means for processing a video signal for displaying said first program contents and said second program contents simultaneously on a single display screen, said first program contents and said second program contents being different; and
means for up-sampling said decoded secondary video stream for replacing said first program contents with said second program contents on said screen in response to a request by a user, wherein:
said receiving means receives and decodes a second regular video stream, said second regular video stream carries third program contents, said second regular video stream is synchronized with said secondary video stream in a time domain, said third program contents are identical to said second program contents and
said processing means replaces said second program contents with said third program contents when an instantaneous decoder refresh (IDR) frame in said second regular video stream is received and decoded.

6. The apparatus of claim 5 wherein:
a length of the group of pictures (GOP) of said secondary video stream is shorter than a length of the GOP of said first regular video stream.

7. A method comprising the steps of:
receiving and decoding a first regular video stream for display, said first regular video stream carrying first program contents;
requesting the transmission of a secondary video stream and a second regular video stream in response to a first request by a user, said secondary video stream carrying second program contents and said second regular video stream carrying third program contents, said first program contents and said second program contents being different while said second and third program contents being identical, said second regular video stream being synchronized with said secondary video stream in a time domain;
receiving and decoding said secondary video stream for displaying said first and second video contents simultaneously on a single display screen
storing at least the latest GOP of said second regular video stream; and
decoding said stored second regular video stream for replacing said first program contents with program contents of said cashed second regular video stream on said display screen in response to a second request by a user.

8. The method of claim 7 wherein:
a length of the group of pictures (GOP) of said secondary video stream is shorter than a length of the GOP of said first regular video stream

9. An apparatus comprising:
a receiver, including at least one video stream receiver and one decoder, for receiving and decoding a first regular video stream, said first regular video stream carrying first program contents; and
a memory, wherein:
said receiver sends at least one request command for the transmission of a secondary video stream and a second regular video stream in response to a first request by a user, said secondary video stream carries second program contents and said second regular video stream carries third program contents, said first program contents and said second program contents are different while said second and third program contents are identical, said second regular video stream is synchronized with said secondary video stream in a time domain;
said receiver receives and decodes said secondary video stream for displaying said first and second video contents simultaneously on a single display screen and stores at least the pre-decoded latest GOP packets of said second regular video stream in said memory;
said receiver decodes said stored second regular video stream for replacing said first program contents with program contents of said cashed second regular video stream on said display screen in response to a second request by a user.

10. The apparatus of claim 9 wherein:
a length of the group of pictures (GOP) of said secondary video stream is shorter than a length of the GOP of said first regular video stream.

11. An apparatus comprising:
means, including at least one video stream receiver and one decoder, for receiving and decoding a first regular video stream, said first regular video stream carrying first program contents; and
means for storing digital data, wherein:
said receiving means sends at least one request command for the transmission of a secondary video stream and a second regular video stream in response to a first request by a user, said secondary video stream carries second program contents and said second regular video stream carries third program contents, said first program contents and said second program contents are different while said second and third program contents are identical, said second regular video stream is synchronized with said secondary video stream in a time domain;
receiving means receives and decodes said secondary video stream for displaying said first and second video contents simultaneously on a single display screen and stores at least the pre-decoded latest GOP packets of said second regular video stream in said memory;
receiving means decodes said stored second regular video stream for replacing said first program contents with program contents of said cashed second regular video stream on said display screen in response to a second request by a user.

12. The apparatus of claim 11 wherein:
a length of the group of pictures (GOP) of said secondary video stream is shorter than a length of the GOP of said first regular video stream.
